(19) United States
(12) Patent Application Publication
(10) Pub. No.: US 2008/0245231 A1
(43) Pub. Date: Oct. 9, 2008

(54) Piston, Especially Cooling Channel Piston, of an Internal Combustion Engine, Comprising Three Friction Welded Zones

(75) Inventors: Volker Gniesmer, Alfeld (DE); Gerhard Luz, Nordheim (DE); Emmerich Ottlickzky, Furchtenberg (DE)

Correspondence Address: YOUNG & BASILE, P.C., 3001 WEST BIG BEAVER ROAD, SUITE 624, TROY, MI, 48084, US

(73) Assignee: KS KOLBENSCHMIDT GMBH, Neckarsulm (DE)

(21) Appl. No.: 12/066,890

(22) PCT Filed: Sep. 17, 2005
(86) PCT No.: PCT/EP05/10063

§ 371 Date: Apr. 10, 2008

(51) Int. Cl. F16J 1/00

(52) U.S. Cl. 92/255

(57) ABSTRACT

A piston, such as a cooling channel piston of an internal combustion engine, has a first part, a second part and a third part. The parts can be produced separately from each other and subsequently assembled by way of a joining method. The third part has at least one rotationally symmetrical joining area disposed in direction of the first part, and, another rotationally symmetrical joining area disposed at least in the direction of the second part. The joining areas mate with joining areas of the first part and the second part.

The invention relates to a piston, especially a cooling channel piston of an internal combustion engine.

A cooling channel piston of an internal combustion engine is known from U.S. Pat. No. 6,155,157. In this cooling channel piston, a first part and a second part are manufactured separately from each other and subsequently joined together by means of a joining process (in this case a friction-welding process) to form a single-piece cooling channel piston which forms a cooling channel approximately behind the ring zone to circulate a cooling medium. The construction and manufacture of such a cooling channel piston is relatively simple, but there are severe limitations with respect to latitude in geometry.

It would be desirable to refine the known cooling channel piston in such a way that, when designing the piston with its elements that are intrinsically known, greater latitude is provided.

### SUMMARY

In accordance with the invention, the cooling channel piston has at least one third part, where the third part has at least one rotationally symmetrical joining area in the direction of the first part, and similarly has a rotationally symmetrical joining area in the direction of the second part. The joining areas of the third part mate with the joining areas of the first and second parts. As a result, each part from which the cooling channel piston is later assembled can be matched to the installation location inside the cooling channel piston with respect to material selection and design factors. Consequently, it is possible to manufacture the three parts (or more parts if necessary) from one and the same material or from at least two different materials. For example, at a thermally stressed part of the cooling channel piston, a part can be made from a material which is more heat-resistant than the material of which the remaining parts consist. Supplemental or as an alternative to this, it is possible to manufacture the at least three parts using the same method or using different methods.

In one aspect, the joining procedure involves friction-welding which it allows processing all three joining areas simultaneously, thus solidly joining the at least three parts. In addition, consideration can be given to manufacturing the parts, which can then consist of the same or different materials, using the same or different procedures such as forging, casting, pressing, extruding, stamping and similar. For example, one part can consist of a more heat-resistant material than the other part or parts for the purpose of reinforcement, such as the edge of the combustion bowl and/or the surface of the piston head. Weight considerations also play a part here. For example, the at least one part can consist of a lightweight material such as aluminum, while the at least one additional part consists of a ferrous material for example, gray cast iron.

After the at least three parts have been manufactured independently of each other, they are joined by means of a joining method, specifically by means of friction-welding. It must be remembered that initially two parts can be joined and the third part added subsequently. The simultaneous joining of all three parts is also conceivable, where this is more expensive compared with the joining procedure performed sequentially. Initially joining two parts also has the advantage that at least one part or all points of the joining area are openly accessible for machining and further treatment. The machining of the joining area involves in particular the removal of a joining flash, while the application of a protective coat or similar, for example, must be mentioned under further treatment. If the area to be machined is subsequently to be a cooling channel or a hollow space intended for weight reduction, great degrees of latitude exist with the single- or two-stage joining method for machining the spaces which form the cooling channel or the hollow space since they are still optimally accessible and thus available for machining. For example, undercuts can be realized which can be achieved with a cast piston only with expensive coring and with other pistons not at all. After this machining (and further treatment as required) is completed, the two parts already joined are attached to the third part. Here too, consideration can be given once again to subsequent machining (and further treatment as required). After all three parts have been joined, additional machining of the outer surface of the almost completed cooling channel piston is usually performed, in particular to bring it to the correct size. This machining applies to the outer surfaces of the cooling channel piston while usually the inner areas of the piston which do not come into contact with the running surfaces of the cylinder remain unmachined.

In a refinement, the joining areas aligned with one another between the third part and the first part are disposed in at least one joining plane and the joining areas aligned with one other between the third part and the first part are disposed in at least one different plane deviating therefrom. The result is greater latitude in the design of the individual parts of the cooling channel piston and their functions, where in an advantageous way the manufacturing aspects are taken into account. The joining areas of the two parts facing each other, which are configured in an advantageous way as rotationally symmetrical joining webs, can be shaped such that two parts are optimally joined in a first procedural step, and in a second procedural step the additional part can subsequently be attached to this combination of parts.

In another aspect, the three parts of the cooling channel piston are shaped such that, after they have been joined, they form at least one cooling channel lying behind a ring zone of the cooling channel piston. This again emphasizes that the at least three parts are shaped and are joined such that they jointly form the cooling channel lying behind the ring zone of a cooling channel piston. Thus, all three parts of the cooling channel piston contribute to form the cooling channel. At this point it should be mentioned that one part which closes the cooling channel, the channel being open after its manufacture, does not fall under the term of first, second or third part. The at least three parts described here are essential components of the cooling channel piston.

### BRIEF DESCRIPTION OF THE DRAWING

Various aspects of a fully developed cooling channel pistons are described using FIGS. 1 to 7.

FIG. 1 depicts a first embodiment of a cooling channel piston;

FIG. 2 depicts a second aspect of a cooling channel piston;

FIG. 3 depicts a third aspect of a cooling channel piston;

FIG. 4 depicts a fourth aspect of a cooling channel piston;

FIG. 5 depicts a fifth aspect of a cooling channel piston;

FIG. 6 depicts a sixth aspect of a cooling channel piston; and

FIG. 7 depicts a seventh aspect of a cooling channel piston.

### BRIEF DESCRIPTION OF THE DRAWING

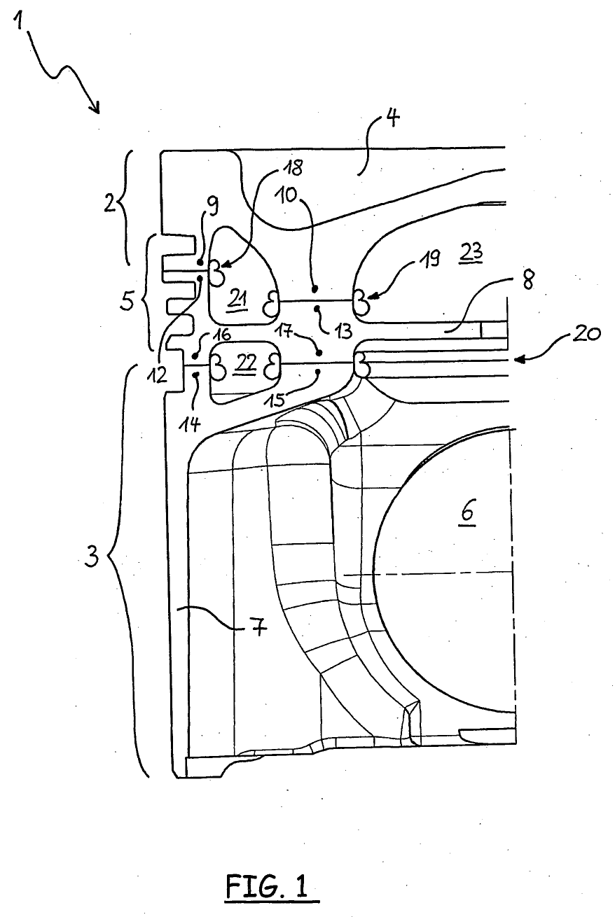

FIG. 1 shows a piston in a half-sectional view, here a cooling channel piston 1 of an internal combustion engine, which has a first part 2 (i.e., a piston head) and a second part 3, (i.e. a piston lower part). Further, there are a combustion bowl 4, a radially peripheral ring zone 5 (shown by example with three ring grooves), a piston-pin bore 6 and a piston skirt 7. In the aspect shown in FIG. 1, there is a third part 8 which is configured as an intermediate part between the first part 2 and the second part 3. Here it can be seen very clearly that the three parts 2, 3 and 8 are shaped such that after they have been joined, the three parts 2, 3, and 8 form at least one hollow space or cooling channel lying approximately behind the ring zone 5 of the cooling channel piston 1, which will be discussed later. Furthermore it is shown that the first part 2 has joining areas 9, 10 which point in the direction of joining areas 12, 13 of the third part 8 and mate with the joining areas 12, 13. Similarly, the second part 3 has joining areas 14, 15 which point in the direction of joining areas 16, 17 of the third part 8. All the joining areas 10 to 17, which are configured here as radially peripheral joining webs, have in common that they are matched to each other with respect to their mutual arrangement, particularly concerning their position in the specific plane and their width. The joining areas 9, 12 lie in a first joining plane 11B, the joining areas 10, 13 in a second joining plane 19 and the joining areas 14, 16, and 15, 17 in a common third joining plane 20, where it is conceivable that joining areas 14, 16 and 15, 17 lie in different joining planes, just as the first joining plane 18 and the second joining plane 19 may be disposed in one and the same joining plane. Because of the shape of the joining areas 10 to 17 of the three parts 2, 3 and 8, not only one cooling channel 21 lying behind the ring zone 5 of the cooling channel piston 1 is realized, but a second cooling channel 22 is present. Reference numeral 23 designates an inner area 23 of the cooling channel piston 1 located below the combustion bowl 4, where those design measures which represent the supply and removal of cooling medium from the at least one cooling channel 21, 22 have not been shown in the drawing. Such measures (such as apertures, drilled holes and similar) are intrinsically known and can be introduced after the joining of the three parts 2, 3, 8. With respect to the joining of the three parts 2, 3, 8, it must be explained again that these parts 2, 3, 8 are manufactured from the same material separately from each other, or from different materials in one and the same manufacturing process, or in processes differing from each other and subsequently joined. For example, the third part 8 is first joined to the second part 3 in a friction-welding procedure so that the joining points inside the cooling channel 21 which is still open at the top at this point can be machined (but do not have to be). Then the parts 3, 8, which are already joined, are joined to the first part 2, also in a friction-welding procedure when the joining locations can be machined (but again do not have to be). The machining of the joining points can be considered when they are at locations which obstruct the later operation of the cooling channel piston 1. Consequently, these particular joining points on the outer surface (contact surface) of the cooling channel piston are removed.

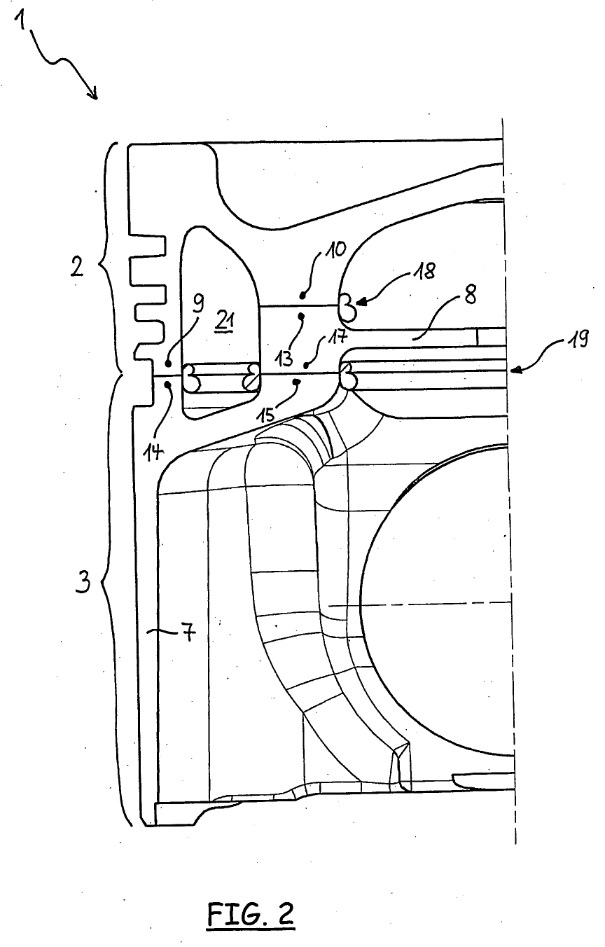

FIG. 2 depicts a further aspectd of the cooling channel piston with the three parts 2, 3, 8, where here the two joining areas 10, 13 in the first joining plane 18 and the additional joining areas 9, 14 and 15, 17 in a second joining plane mate with each other. The same explanations apply with respect to manufacture and joining of the parts described above as for FIG. 1.

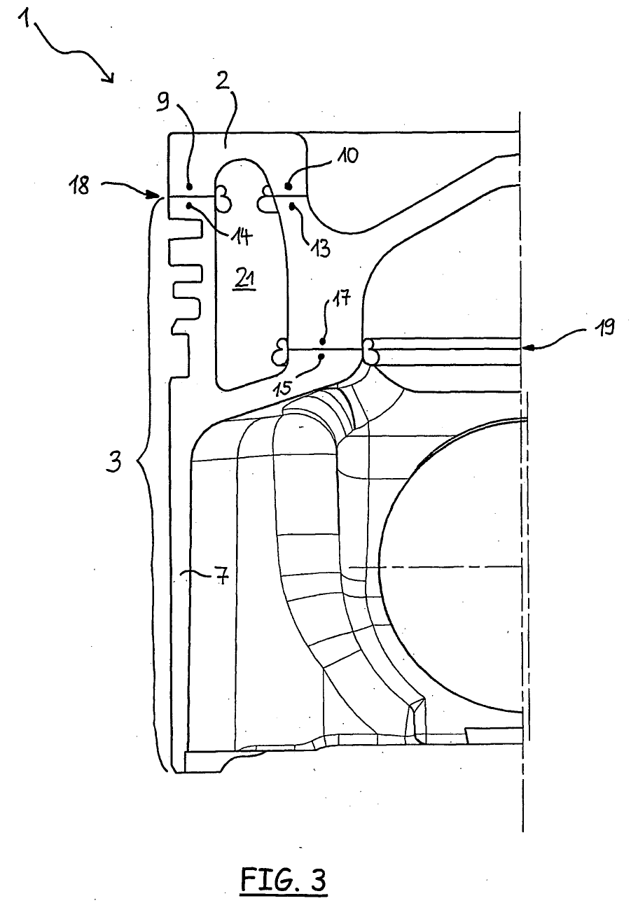

FIG. 3 depicts a third aspect of the cooling channel piston 1, where the first part 2 is shaped such that it forms only a part of the combustion bowl (in contrast to FIG. 2 where the first part 2 completely surrounded the combustion bowl 4). The configuration of the first part 2 shown in FIG. 3 can be manufactured specifically from a more heat-resistant material than the part 8 in order to design the piston head and above all the edge of the combustion bowl 4 to be more heat-resistant since particular stress is placed on the cooling channel piston 1 in these areas. Because of this design of the parts 2, 3 and 8, the joining areas 9, 14 and 10, 13 mate in the first joining plane 18 and the joining areas 15, 17 mate in the second joining plane and are shaped such that only one cooling channel results after the parts 2, 3, 8 have been joined.

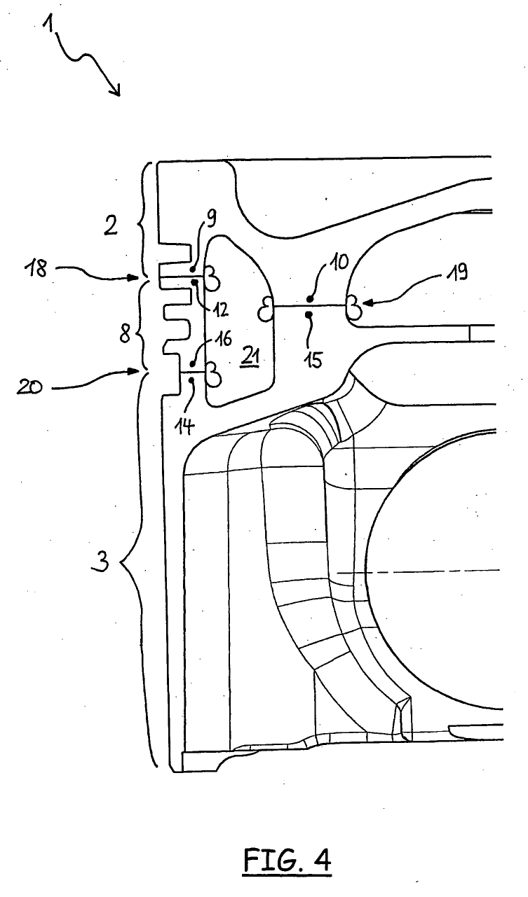

FIG. 4 depicts a fourth aspect of the cooling channel piston 1, where again the parts 2, 3, 8 together form the cooling channel, and here the third part 8 is configured as a connecting piece between the first part 2 and the second part 3 in the vicinity of the ring zone. The joining areas 9, 12 mate with each other in the first joining plane 10, joining areas 10, 15 mate in the second joining plane 19 and joining areas 14, 16 mate in the third joining plane 20. Here again, it is clearly evident that the joining areas of the respective parts 2, 3, 8 facing each other match each other in position and shape.

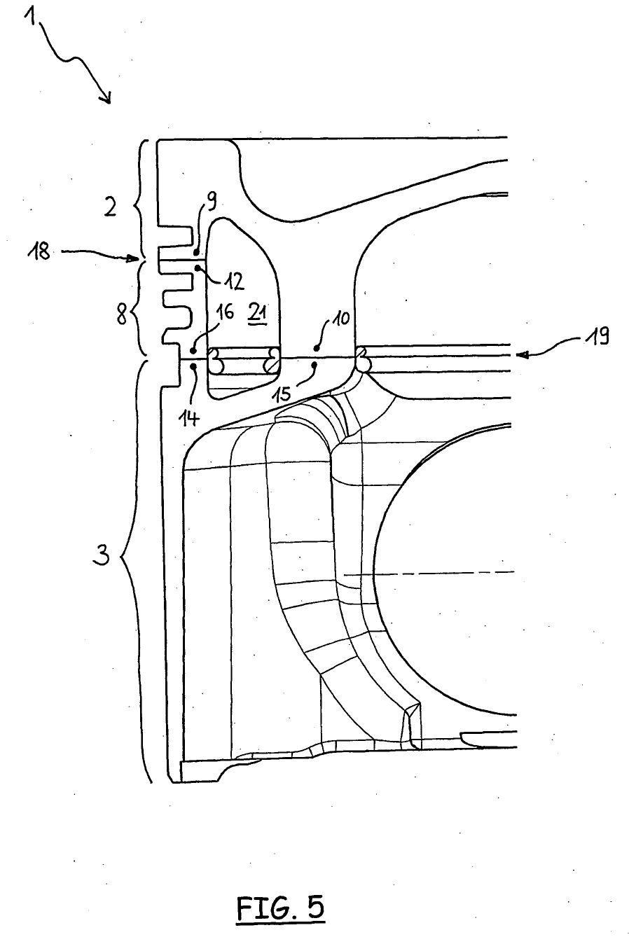

FIG. 5 depicts a modification of FIG. 4, where the first part 2 and the second part 3 are shaped such that the joining areas 14, 16 and 15, 19 lie in common in the second joining plane 19 and a third joining plane does not exist.

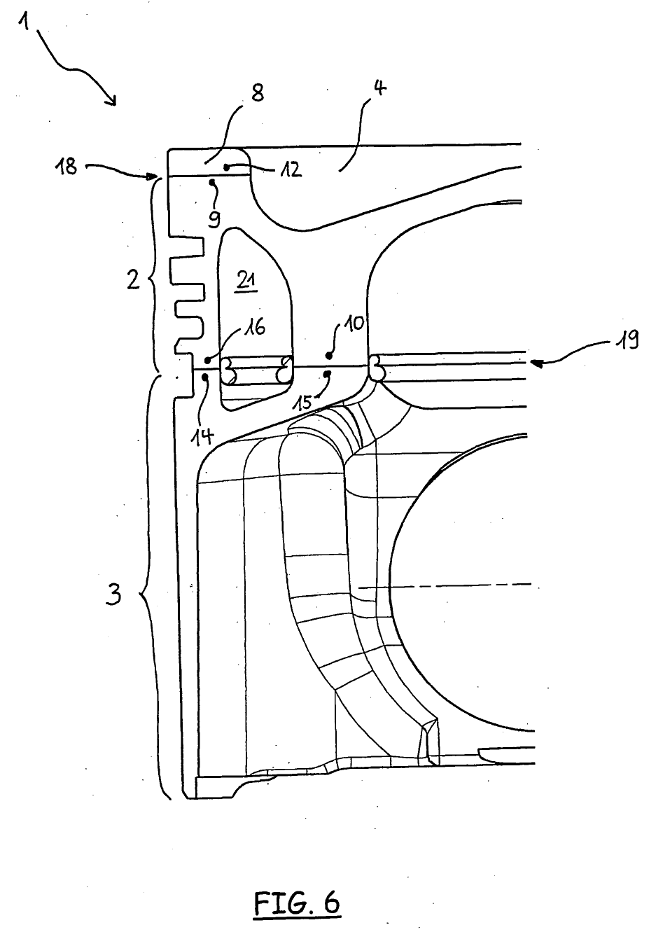

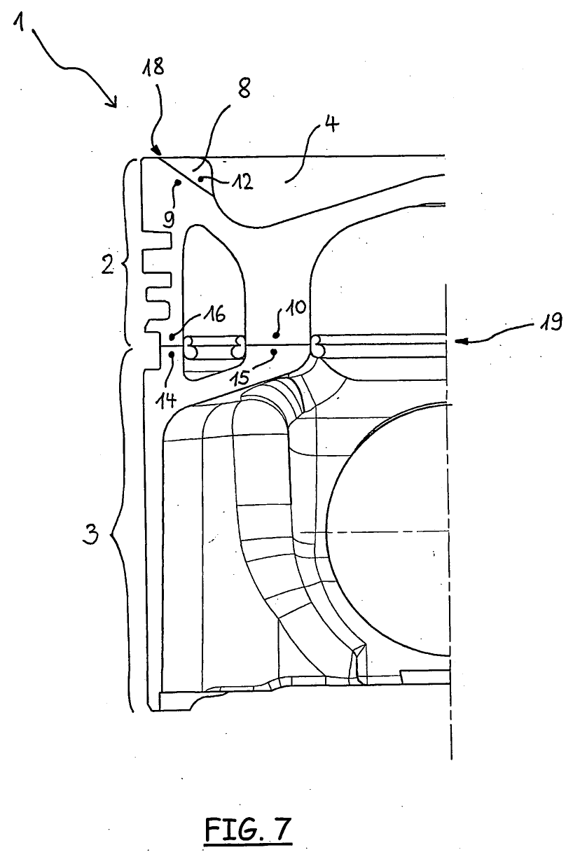

FIGS. 6 and 7 show the piston, or cooling channel piston 1, in which at least one of the parts 2, 3, 8 is configured as reinforcement for one partial surface of the piston or of the cooling channel piston 1. In FIG. 6, the third part 8 is configured as reinforcement for a piston head and in FIG. 7 as reinforcement for the edge of the combustion bowl 4 of the piston or the cooling channel piston 1. This part 8 is also attached solidly, specifically in a friction-welding procedure.

1. A piston of an internal combustion engine having a first part, a second part and at least one third part which are manufactured separately from each other and then joined together, where the third part has at least one rotationally symmetrical joining area disposed in the direction of a second part and has at least one rotationally symmetrical joining area disposed in the direction of the first part, the joining areas of the third part mating with joining areas of the first and second parts.

2. A piston from claim 1, wherein the joining areas facing each other between the third part and the first part are disposed in at least one joining plane and the joining areas facing each other between the third part and the second part are disposed in at least one joining plane diverging from the at least one joining plane.

3. A piston from claim 1, wherein the first, second and third parts are designed to form at least one hollow space approximately behind a ring zone of the piston, after the first, second and third parts have been joined.

4. The piston from claim 1, wherein the first, second, and third parts are formed by friction-welding.

5. The piston from claim 1, wherein the parts are formed of one of the same material and different materials.

6. The piston from claim 1, wherein at least one of the first, second and third parts is configured as reinforcement for a partial upper surface of the piston.

7. The piston from claim 6, wherein the reinforcement is configured for one of a head and a bowl edge of the piston.
